(19) United States
(12) Patent Application Publication
(10) Pub. No.: US 2009/0101685 A1
(43) Pub. Date: Apr. 23, 2009

(54) Apparatus for transporting refuse cans

(76) Inventor: Patrick M. Robb, Granville, OH (US)

Correspondence Address: MILLER & BARNS, PLLC, 230 EAST BROADWAY, SUITE 250, GRANVILLE, OH, 43023, US

(21) Appl. No.: 11/975,742

(22) Filed: Oct. 19, 2007

(51) Int. Cl. B60R 9/00

(52) U.S. Cl. 224/495; 224/548

(57) ABSTRACT

The present invention provides for the safe and easy transport of refuse cans such as standard residential refuse cans. The present invention includes a removably mountable refuse can transport device that is mounted to a vehicle by a hitch engagement such as an insert to a conventional trailer hitch, a vertical support mounted with a base that supports a refuse can and a locking plate that moves vertically to retain a refuse can on the base to allow convenient transport of the refuse can.

### RELATED U.S. PATENT APPLICATIONS

This Application is a Continuation-In-Part of U.S. patent application entitled “APPARATUS FOR TRANSPORTING REFUSE CANS” Inventor Patrick M. Robb, Ser. No. 339,395, Publication Number 20070170218.

### TECHNICAL FIELD AND INDUSTRIAL APPLICABILITY

The present invention relates to a device for transporting refuse cans that is simple to use and provides reliable transportation to a wide variety of refuse cans. More particularly, the invention relates to an apparatus for transporting a standard residential refuse can. Even more particularly, the invention is directed to a device that may be removably attached to a vehicle to receive a refuse can for transport.

### BACKGROUND OF THE INVENTION

In recent years, household refuse collection services have encouraged the use of wheeled, lidded refuse cans typically having a capacity of 65 to 94 gallons or more. The use of these cans allows the operator of a refuse collection truck to use a hydraulic lift to raise the can to dump refuse into the truck. As shown in FIG. 5, and disclosed in U.S. Pat. No. 5,826,485 (herein incorporated by reference in its entirety) a lifting apparatus 20 for dumping a refuse can 26 may be mounted on a rear bumper 24 of a refuse collection truck 22. The refuse can 26 typically includes a detent or engagement surface 30 and often includes a second engagement surface 32 by which the refuse can 26 is raised so that the refuse may be dumped into the opening 28 in the refuse truck 22. Lifting apparatus 20 commonly includes a faceplate 34 for clearance between the bottom portion 36 of the lifting apparatus 20 and the road surface 38. By using apparatus 20, the operator only needs to position the refuse can 26 and operate a hand valve 40 to hydraulically lift the refuse can 26. The hydraulic lift improves the efficiency and ease of collecting refuse and decreases injuries to refuse collectors related to lifting the heavy cans 26.

While these cans are convenient for the operator of a refuse truck, they are larger than conventional refuse cans and it can be difficult for a homeowner to transport the larger refuse cans to the street for trash collection. This problem is especially pronounced in rural areas where the distance the refuse can must be transported can be great.

One conventional system that simplifies the transport of large refuse cans is the “Trash Caddy”. In the “Trash Caddy”, the can is tilted down so that the handle of the can engages one of two hooks extending from a beam that is secured to the receiver hitch of a vehicle. The “Trash Caddy” has several drawbacks, however, including the difficulty of raising and lowering a full refuse can. Large 96-gallon refuse cans typically have a rated capacity of 250 pounds. Additionally, the “Trash Caddy” relies on the wheels of the refuse can to support the weight of the can during transport. Typically, the wheels are not designed for long distance transport and can either be bent, damaged, or worn during extended transport.

Other mechanisms for transporting materials or refuse cans have been designed, as discussed below. However, each of these alternative designs has one or more drawbacks including: high cost to manufacture, exposed pinch points, reliance on spring mechanisms or slow rotating crank mechanisms.

U.S. Pat. No. 2,338,955 to Hollis H. Metcalf discloses an automobile carrier mounted on the rear bumper and trunk of a vehicle. The lift mechanism is rotatable around a fulcrum such that the lift mechanism is pivoted up toward the vehicle after loading.

U.S. Pat. No. 6,033,178 discloses a transporter for a refuse can that includes a support frame mounted on a vehicle and an articulating frame mounted to the support frame that is capable of reciprocal upward and downward movement by operation of a hand lever attached to both the support and the articulating frame. Springs are positioned between the two frames to provide a mechanical advantage in lifting the refuse can.

U.S. Pat. No. 6,361,264 discloses a transporter for a refuse can that includes a post with a track, a lifter supported on the post that moves longitudinally to both raise and lower the refuse can. The '264 Patent also discloses upper and lower wheeled trucks which ride on the track within the post and which are attached to the lifter with a cable and a rotatable lift handle to raise and lower the refuse can.

U.S. Pat. No. 6,698,995 discloses a structure similar to that of U.S. Pat. No. 6,361,264 but with a telescoping mount and a lead screw on the post. The lead screw is connected to the telescoping mount for raising and lowering the telescoping mount.

Although there are many refuse transporting devices for transporting refuse cans in existence, an apparatus for transporting refuse cans that has a low manufacturing cost and that possesses ease and speed in use without the reliance on springs or cranks is much sought after. Accordingly, there is a need for a safe, strong, and easy-to-use refuse can transport apparatus.

### SUMMARY OF THE INVENTION

The invention of the present invention includes a removably mountable refuse can transport device that is mounted to a vehicle by a hitch engagement such as an insert to a conventional trailer hitch, a vertical support mounted with a base that supports a refuse can and a locking plate that elevates to retain a refuse can on the base, to allow convenient transport of the refuse can. In one preferred embodiment of the present invention, the locking plate is biased upward such that when a refuse can contacts the device the plate moves upward to engage the refuse can and securely retain the can on the transport device. In another preferred embodiment, a bias control member is used to bias the locking plate and a release control member is coupled to the locking plate. In an alternate embodiment of the invention the refuse can transporting device includes a support frame that temporary attaches to a motor vehicle, and a support on the frame that moves vertically to move a retaining bracket into and out of engagement with a refuse can. Preferably, the retaining bracket includes a vertical portion for engaging a refuse can. Preferably, the refuse can sits on a support mounted on a lower end of the supporting frame during transport.

### BRIEF DESCRIPTION OF THE DRAWINGS

FIG. 1 is a plan view of a device for transporting refuse cans in accordance with the present invention in which the transporting device is mounted on a vehicle in preparation for engagement with a refuse can.

FIG. 2 is a plan view of a device for transporting refuse cans in accordance with the present invention in which the transporting device is mounted on a vehicle and engaged with a refuse can.

FIG. 3 is an exploded perspective view of a device for transporting refuse cans in accordance with the present invention.

FIG. 4 is a plan view, in detail of a device for transporting refuse cans in accordance with the present invention.

FIG. 5 is a perspective view of a refuse truck with an attached lifting system and a refuse can in accordance with the prior art.

### DETAILED DESCRIPTION AND PREFERRED EMBODIMENTS OF THE INVENTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are described herein. All references cited herein, including published or corresponding U.S. or foreign patent application, issued U.S. or foreign patents, or any other references, are each incorporated by reference in their entireties, including all data, tables, figures, and text presented in the cited references. In the drawings, the thickness of the lines, layers, and regions may be exaggerated for clarity. It is to be noted that like numbers found throughout the figures denote like elements.

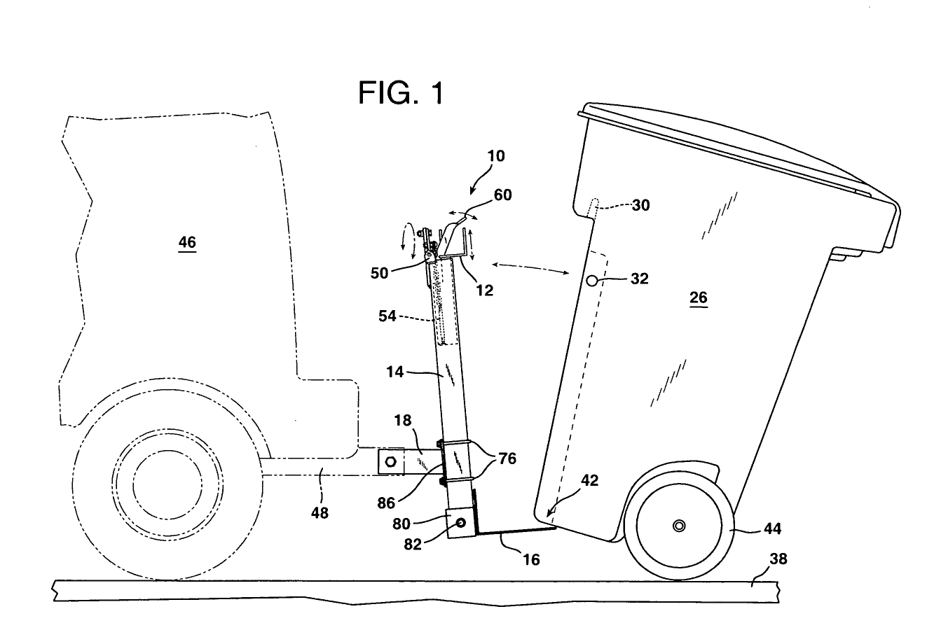

In order to develop a safe, strong, and easy-to-use refuse can transport-apparatus, the present invention provides a mechanism which may be quickly and easily installed and removed on a vehicle and which secures a refuse can safely and securely. Turning to FIG. 1, the refuse can transport apparatus 10 may be installed into a hitch mount 48 of a vehicle 46 or, alternatively, it may be installed over a standard ball hitch (not shown). The vehicle 46 shown in FIG. 1 includes a hitch receiver 48 into which a receiver insert 18 is received. The hitch receiver insert 18 may include a hitch plate 86 to which an upright support 14 may be retained by square U-bolts 76. At the lower portion of the upright support 14 is a base 16 for supporting a refuse can 26. At the upper end of the upright support 14 is a locking plate 12 that may be biased upward toward a lock position from a release position by lever 50 and spring 54. FIG. 1 shows the lever 50 in the ‘unbaised’ position, which allows the locking plate 12 to be released from the lock position.

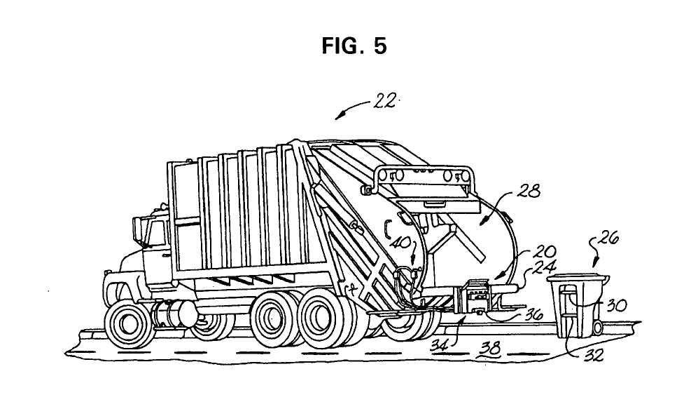

As seen in FIG. 1, the refuse can 26 includes an engagement member 30 and optionally a second engagement member 32. The second engagement member 32 is typically in the form of a bar (as shown in FIG. 5) or may be a detent. The refuse can 26 also includes a lower surface 42 and wheels 44.

In order to transport the refuse can 26, the refuse can transport apparatus 10 can is mounted on vehicle 46 and the refuse can 26 is positioned adjacent the apparatus 10. The refuse can 26 is then rotated back and pushed forward until the lower surface 42 of the refuse can 26 rests upon the base member 16 of the apparatus 10. The can is then rotated upward (arrow) so that the weight of the refuse can 26 is supported by the base 16. The device 10 preferably includes a hitch receiver insert 18 that may be coupled to a hitch receiver 48 of a vehicle. In order to adjust the height of the apparatus 10, a hitch plate 86 and square U-bolts 76 are provided which allow the apparatus 10 to be raised or lowered depending upon the height of the vehicle and the terrain over which a refuse can 26 is to be transported. While it is preferred that the apparatus 10 be as low as possible to ease the loading and unloading of the refuse can 26, the apparatus 10 may be raised to account for a steep or uneven surface 38 of a driveway or road. The base 16 may be fixed directly to the upright support 14 or, as shown, the base 16 may be mounted to a base connector 80 attached to support 14 by bolt 82.

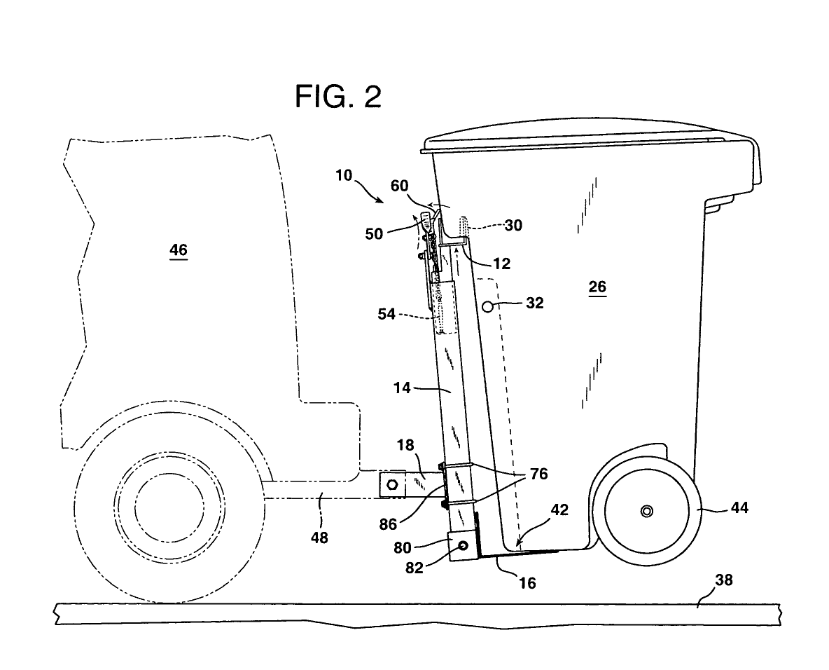

As shown in FIG. 2 the engagement member 30 of refuse can 26 contacts the locking plate 12 to retain the refuse can 26 safely and securely on the apparatus for transport. The locking plate 12 is urged upwardly (arrow) by spring 54 to secure the engagement member 32. As shown in FIG. 2, with the lever 50 in the up position to bias the locking plate 12 upward. The operator raises the can 26 such that the engagement member 30 is positioned over the locking plate 12. The can 26 contacts the retaining mechanism 60 to release the spring-loaded locking plate 12 causing plate 12 to raise and contact engagement member 30. The locking plate 12 secures the engagement member 30 whether the engagement member 30 is a detent (shown in FIG. 2) or a bar (shown in FIG. 5). Once the refuse can 26 is safely locked onto the transport apparatus, the vehicle 46 may be driven to the desired location for trash removal and the refuse can 26 may be quickly and easily released.

In order to release the can, the locking lever 50 is lowered to the release position. In the release position, the spring 54 no longer urges the locking plate 12 upwardly and into the engagement member 30. However, the weight of the refuse can 26 retains the locking plate 12 in the lock position. To release the locking plate, the operator simply pushes the refuse can 26 toward the apparatus 10, which removes the force from the locking plate 12, thereby allowing the plate 12 to fall to the release position. The refuse can 26 may then be lowered to the ground and left for refuse collection.

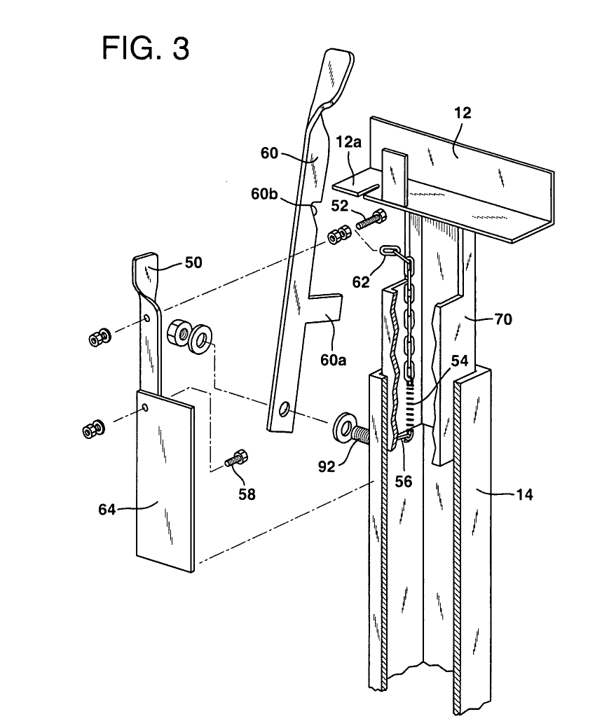

FIG. 3 shows a detailed view (partially cut away) of a locking mechanism for a refuse can transport apparatus 10 in accordance with the present invention. At the upper end of the main upright support 14 is a locking mechanism that engages the refuse can 26 so that the refuse can 26 may be transported safely and easily. The locking mechanism in accordance with one embodiment of the present invention includes a plate 12 that is upward toward an upper ‘lock’ position to a lower ‘release’ position by a lever 50 and a spring 54. By rotating the lever 50 upwardly about the bolt 58, the spring 54 is placed in tension by resilient member 62. The locking plate 12 is biased upward but is secured by retaining mechanism 60. The retaining mechanism 60 includes a detent 60b and may optionally include a counter weight (not shown) or a strike plate 60a to improve the action of the retaining mechanism 60. The retaining mechanism is rotatably mounted on upright support 14 by bolt 91 so that detent 60b engages locking plate 12 to hold the upwardly biased plate in the unlocked position. Locking plate 12 may optionally include a lip 12a formed on plate 12 to provide a secure hold. When the refuse can 26 contacts the retaining mechanism 60 the locking plate is released and contacts engagement member 30 of the refuse can 26.

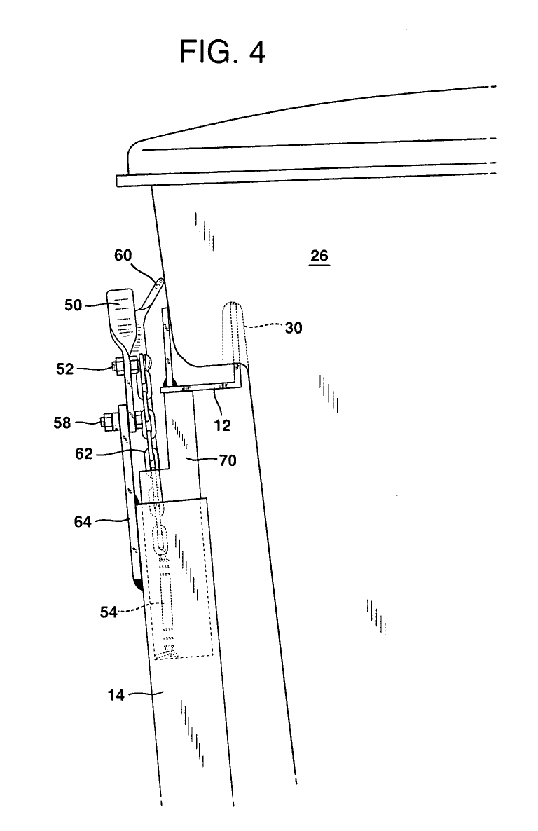

As shown in the exploded view of FIG. 4, one preferred construction of the apparatus 10 of the present invention includes an upright support 14 having a locking mechanism at the upper und thereof. The locking mechanism includes a lever 50 rotatably mounted, for example by bolt 58, on stanchion 64 on upright 14. A movable support 70 is positioned parallel and preferably within upright support 14. The movable support includes a spring retainer, such as a hook on a lower portion thereof. The spring is preferably connected to lever 50 by a flexible connector such as chain 62. Lever 50 includes a connector, such as bolt 52 for engaging a spring 54. Lever 50 may be rotated from a first position to a second position to place tension on spring 62 to bias locking plate upwards.

The invention of this application has been described above both generically and with regard to specific embodiments. Although the invention has been set forth in what is believed to be the preferred embodiments, a wide variety of alternatives known to those of skill in the art can be selected within the generic disclosure. The invention is not otherwise limited, except for the recitation of the claims set forth below.

I claim:

1. A removably mountable refuse can transport device, comprising:
a hitch engagement for engaging a vehicle;
a vertical support mounted on the hitch engagement;
a base on a lower end of the vertical support for receiving a refuse can; and
a movable locking plate at an upper end of the vertical support having an upper, locked position for retaining a refuse can on the base and a lower, release position for releasing the refuse can from the base; and
an extensible coupler for biasing the locking plate toward the upper position;
wherein a refuse can may be received on the base and rotated upward to engage the locking plate and be retained on the base.

2. The refuse can transport device of claim 1, further comprising:
a control member coupled to the locking plate for retaining the locking plate in the lower, release position until activated to permit the locking plate to move to the upper, locked position to a released position.

3. The refuse can transport device of claim 2, further comprising:
a movable coupler positioned between the lock and release control member and the rotatable locking plate.

4. The refuse can transport device of claim 3, wherein the extensible coupler is a spring.

5. The refuse can transport device of claim 3, wherein the extensible coupler biases the locking plate upward toward the locked position in preparation for engagement with an engagement mechanism on the refuse can; and
wherein the locking plate is maintained in the locked position during transport of a refuse can.

6. The refuse can transport device of claim 2, wherein the locking plate is retained in the locked position by the extensible coupler until and the weight of the engaged refuse can is removed from the locking plate.

7. The refuse can transport device of claim 1, further comprising a rotatable support for the locking plate, the rotatable support being mounted on the upper end of the vertical support and operable to move the rotatable locking plate from a locked position to a released position.

8. The refuse can transport device of claim 1, further comprising:
a hitch plate positioned between the vertical support and the hitch engagement to allow vertical adjustment of the base.

9. A refuse can transporting device comprising:
a supporting frame for temporary attachment to a motor vehicle;
a movable support coupled to the supporting frame, the movable support being capable of reciprocal upward and downward movement;
a retaining bracket mounted on the movable support for engagement with a refuse can;
an extensible member for moving the movable support into a retaining position;
a retaining mechanism for holding the movable support in a release position; and
a base support mounted on a lower end of the supporting frame for supporting the refuse can.

10. The refuse can transporting device of claim 9, wherein the refuse can may be received on the base and rotated upwardly to engage the retaining mechanism, releasing the movable support and moving the retaining bracket upward to engage the refuse can.

11. The refuse can transporting device of claim 10, further comprising:
an actuator for releasing the tension in the extensible member.

12. The refuse can transporting device of claim 11, wherein the actuator is a hand lever coupled to the supporting frame and to the movable support.

13. The refuse can transporting device of claim 11, wherein the actuator is a hand lever coupled to the supporting frame to control movement of the retaining bracket between a retaining position and a released position.

14. The refuse can transporting device of claim 10, wherein the retaining bracket remains in the release position when loaded by a refuse can.

15. The refuse can transporting device of claim 14, wherein the retaining bracket is released from the retaining position when the refuse can is pushed toward the supporting frame.

16. The refuse can transporting device of claim 11, wherein the retaining bracket remains in the release position when loaded by a refuse can and the retaining bracket is released when the refuse can contacts the actuator.

17. A vehicle mounted container transport device, comprising:
an upright support having upper and lower ends;
at least one movable arm mounted on the upright support;
a movable retaining bracket mounted on the at least one arm;
a spring for biasing the movable arm in an upward direction;
a bracket locking mechanism at the upper end of the upright support, the locking mechanism having a lever for locking and releasing the retaining bracket;
a base mounted on the upright support for supporting a container.

18. The vehicle mounted container transport device of claim 17, further comprising:
a hitch receiver insert mounted to the upright support, the hitch receiver insert allowing for vertical adjustment of the upright member relative to the ground.

19. The vehicle mounted container transport device of claim 18, wherein the hitch receiver insert includes a hitch plate and U-bolts.

20. The vehicle mounted container transport device of claim 17, wherein the at least one movable arm is slidable within the upper end of the upright support.
